(19) United States
(12) Patent Application Publication
(10) Pub. No.: US 2009/0208161 A1
(43) Pub. Date: Aug. 20, 2009

(54) CAGE SEGMENT FOR THE CAGE OF A ROLLER BEARING

(75) Inventors: Dieter Jauernig, Herzogenaurach (DE); Martina Gramann, Altdorf (DE); Herbert Rost, Herzogenaurach (DE); Rudolf Zeidlhack, Essleben (DE); Horst Geissdoerfer, Vehlfeld (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/300,808

(22) PCT Filed: May 10, 2007
(86) PCT No.: PCT/DE07/00852

§ 371 Date: Dec. 9, 2008

(30) Foreign Application Priority Data
May 17, 2006 (DE) 10 2006 022 951.7

(51) Int. Cl. F16C 33/46

(52) U.S. Cl. 384/572

(57) ABSTRACT

The invention relates to a cage segment for the cage of a roller bearing, having at least two peripheral sections extending in the peripheral direction and at least two connecting sections. The peripheral sections and the connecting sections form at least one pocket for receiving a rolling body. The cage segment has a coupling unit which connects the front of the cage segment to another cage segment.

### FIELD OF THE INVENTION

The invention relates to a cage segment for the cage of a roller bearing, a cage formed therefrom and a roller bearing with such cage segments. The invention is described with reference to large roller bearings (with a pitch circle diameter greater than 500 mm) for all bearing designs.

Cages for roller bearings are widely known and have the function of providing cage pockets inside which rolling bodies are held and guided. During operation of such a roller bearing, however, swelling or thermal expansion of the material from which the cage segments are made may occur. This may result in high stresses in the cage because usually the material of the cage or the cage segments is subject to a far greater degree of thermal expansion than the roller bearings which are usually made of steel. The mechanical stresses can lead to an increase in the friction, seizing or even breakage of the cage.

Moreover, the publication DE 102 46 825 A1 proposed, for example, forming a cage from several cage segments which are not connected together, i.e. are mounted loose and are dimensioned in such a way that, when arranged in succession, a gap remains between the adjacent end sides of the last and first cage segments, in order to absorb any swelling and/or thermally induced expansion, so that mechanical stresses are prevented. This results in an overall end play. Such cages are employed in particular in play-free or prestressed roller bearings for wind power plants.

The possible gap between the cage segments has, however, the disadvantage that during operation higher forces arise in and between the cage segments as a result of swelling and expansion and may be the cause of plastic deformation or also crack formation in the plastic cage segments. The friction within the bearing may also increase considerably as a result, with the possibility of higher temperatures and/or wear occurring.

Moreover, according to the state of the art, steel bolt cages are known in different designs of roller bearings, for example in roller presses or tunnel heading machines. The disadvantage of such cages is, however, the relatively high production costs and the equally relatively high weight of such cages.

The object of the present invention is to overcome the abovementioned disadvantages and in particular to provide a cage segment for a cage of a roller bearing, with which on the one hand mechanical stresses of a cage for a roller bearing formed from cage segments and on the other hand increased wear on account of constraining forces can be avoided. Furthermore, it is an object of the present invention to provide a cage with such cage segments as well as a roller bearing. In addition the aim is to provide a low-cost cage design and also reduce both the friction and the weight of the cage. A further aim is to provide a segment with adequate strength and rigidity and achieve a satisfactory dimensional accuracy of the cage segment.

Furthermore, a favorable sliding and abrasion behavior as well as a high resistance to chemicals and easy manufacture based on a reliable process are desirable.

Moreover, the aim is to provide a bearing cage which is suitable in particular for large roller bearings as an alternative to steel bolt cages and to this extent provides a solution which is technically equivalent or even better but has a lower cost.

This object is achieved by means of the cage segment according to Claim 1 as well as the cage and the roller bearing according to the dependent claims.

Further advantageous embodiments of the invention are described in the dependent claims.

According to the invention a cage segment for a cage of a roller bearing is provided. The cage segment has at least two circumferential webs extending in the circumferential direction of the cage and at least two connecting webs, the circumferential webs and the connecting webs forming at least one pocket for receiving a rolling body. According to the invention the cage segment comprises a coupling unit which is designed so as to connect the end side of the cage segment to another cage segment.

With the cage segment according to the invention it is possible to construct a cage for a roller bearing in which the cage elements on the one hand are coupled together so that during operation of the roller bearing impact between cage segments can be prevented. On the other hand a cage formed with segments according to the invention can be produced at a lower cost than the steel bolt cages known according to the state of the art.

In a preferred embodiment the coupling unit is designed such that connection with another cage element has a clearance fit. In this way mechanical stresses of the cage formed by the cage segments are avoided since the cage segments are connected together by means of the respective coupling units in such a way that the connection to another cage segment has a clearance fit. As a result, swelling and/or thermal expansion of a cage formed by several cage segments according to the invention can be absorbed in the coupling units, without any mechanical stressing occurring. Preferably, therefore, the coupling unit is configured such that the clearance fit has a value to allow for swelling and thermal expansion of the cage segment.

Thus, in theory, the constructional design of the cage segments is such that a pocket or compartment is formed around each rolling body, and these, arranged in succession, form a common larger unit for several rolling bodies. The cage segment can also be defined in such a way that a wall or a connecting web is situated in the circumferential direction of the cage between each rolling body and these walls or webs are connected on both sides in the circumferential direction to a circumferential web or connecting web which can also be defined as a strip or edge. In this respect the size of the cage segments as well as their number for each rolling body row is determined depending on the bearing size, the track diameter and the bearing race geometry. Preferably 2 to 10 pockets for a corresponding 2 to 10 rolling bodies are provided per cage segment.

Preferably, the cage segment according to the invention has, with respect to the circumferential direction, a first coupling element on a first end side and a second coupling element on a second end side, said coupling elements being designed so as to complement each other. In particular the first and the second coupling elements are designed so that they can be connected together in a form-fitting manner.

During assembly the cage segments are connected together or engaged inside each other in such a way that preferably a substantially uniform distribution of the play occurs along the circumference of the cage and the segments are able to maintain their position also in the event of swelling or thermal expansion.

Furthermore, the first and the second coupling elements may be designed as mutually complementary plug-in connection elements so that cage segments of the same kind can be connected together to form a cage.

A small clearance fit is preferably provided within the plug-in connection so that the small variations, for example resulting from variations in temperature, may be to a large extent absorbed. Moreover, the geometry of the segments is preferably determined such that the distance between the radial guiding diameter of the closed segments and the outer race track of the roller bearing is designed sufficiently large to also absorb any possible additional increases in diameter. This is explained in greater detail with reference to a bearing according to the invention.

Variations in volume, with which to some extent variations in diameter may be associated, can be taken into account, according to the state of the art and the material used, during design of the geometrical form.

Preferably, the first coupling element has a coupling web projecting in the circumferential direction and the second coupling element has a coupling recess for receiving the coupling web of a first coupling element of another cage segment. In particular, the coupling web can be designed as an extension of the circumferential webs.

According to a preferred embodiment the coupling web can be provided with a latching element projecting therefrom and a latching recess is provided in the region of the coupling recess, said latching recess being able to be engaged behind by the latching element of a first coupling element of a further cage segment with reference to the circumferential direction, in order to provide a form-fitting connection. In particular, the latching element can be designed as a pin which can be received in a latching opening in the coupling recess of the second coupling element.

Alternatively, the coupling web may be provided with a latching recess and in doing so, in the region of the coupling recess a latching element is provided so as to engage inside the latching recess of a first coupling element of a further cage segment with respect to the circumferential direction, in order to provide a form-fitting connection. In this respect, the latching element projects from the circumferential web preferably in a longitudinal direction of the cage to be assembled. The latching element can, however, also project radially outwards.

According to a preferred embodiment of the invention, the cage segment is made of a thermoplastic synthetic material, in particular with a glass, carbon or aramide reinforcement.

Furthermore, the thermoplastic synthetic material may comprise polyether ether ketone with a fiber content of between 10 to 50 percent by weight. Other plastics, however, may also be used.

According to a further aspect of the present invention a cage for a roller bearing is provided with several of the cage segments described above and the cage segments are connected together at their end sides with the aid of the coupling units so that they form a closed ring.

The invention is furthermore aimed at a roller bearing with at least one cage segment of the kind described above and at a roller bearing with a cage of the kind described above.

In a preferred embodiment, the connecting webs of the cage are arranged at a distance from the track of an outer race of the roller bearing in a radial direction of the roller bearing. As a result of this spaced-apart arrangement at least limited expansions of the bearing cage are possible without producing stresses deforming the bearing cage. More precisely, in the embodiment described here, the geometry of the cage segments is aligned in such a way that the distance or play between the radial guiding diameter of the closed segments and the outer race track is big enough to also allow for the increases in diameter which are, for example, thermally induced.

Preferably, guiding elements which are directed radially outwards are provided on the connecting webs and are again arranged at a distance from the track of the outer race in such a way that expansion of the cage with respect to the outer race can be absorbed for.

In this embodiment a clearance fit between the individual ring segments is not necessarily required, but advantageous. Conversely, in the above embodiments, which have the said clearance fit, the spaced-apart arrangement with respect to the outer race is not necessarily required since for example thermally induced expansions can be absorbed by means of the clearance fit. Preferably, the inner radius of the track of the outer race and the geometrical outer radius of the connecting webs (or guiding elements) are aligned relative to each other such that swelling or thermally induced increases in the diameter of the cage can be absorbed.

Further advantages and embodiments of the present invention will become clear from the accompanying drawings in which:

FIG. 1 shows a perspective view of a cage segment according to a first embodiment of the invention;

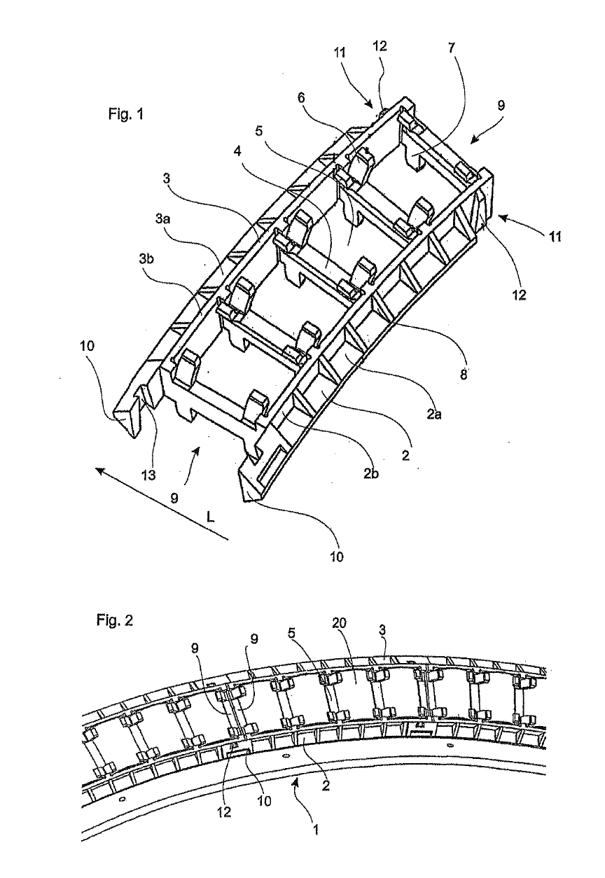

FIG. 2 shows a view of a part of a cage which is formed by the cage segments according to FIG. 1;

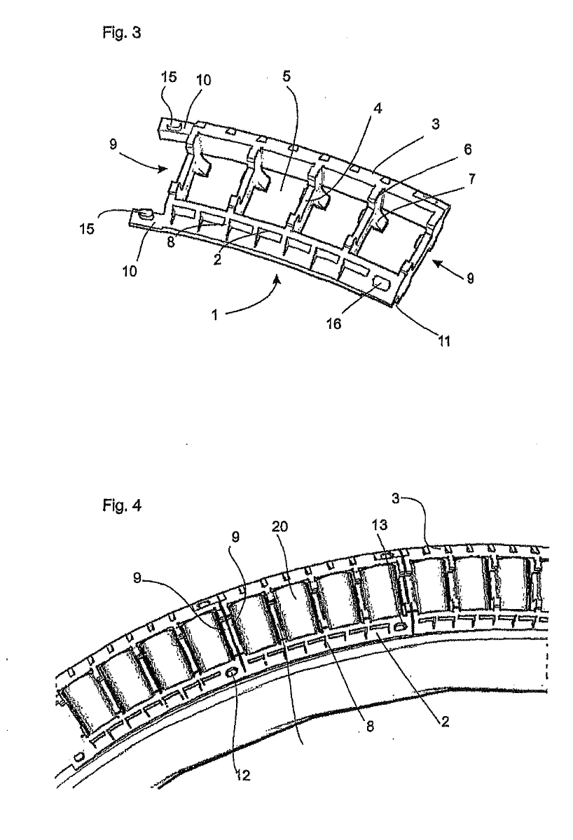

FIG. 3 is a perspective view of a cage segment according to a further embodiment of the invention; and

FIG. 4 is a view of a part of a cage which is formed by the cage segments according to FIG. 3;

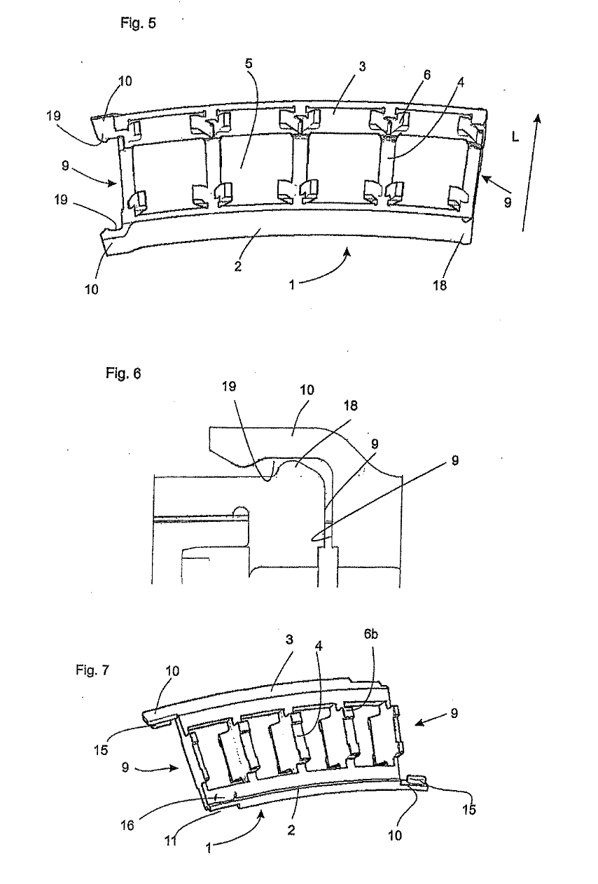

FIG. 5 is a further embodiment of a cage segment according to the invention;

FIG. 6 is a detailed view of two cage segments according to FIG. 5 engaging inside each other; and

FIG. 7 is a further embodiment of a cage segment according to the invention.

FIGS. 1 and 2 show a perspective view of a cage segment and a view of a part of a cage for a roller bearing, in particular for a tapered roller bearing, composed of such cage segments. Such a roller bearing can, for example, be used to support a rotor of a wind power plant.

In order to form a cage, cage segments 1 of the same kind are connected together so as to create a closed ring which forms the cage for the roller bearing. In detail the cage segment 1 has an inner circumferential web 2 and an outer circumferential web 3. The inner circumferential web 2 has here a smaller radius of curvature than the outer circumferential web 3. The rolling bodies to be inserted here have a conical form.

Connecting webs 4 are arranged between the inner circumferential web 2 and the outer circumferential web 3, said webs being situated substantially at the same distance from each other and having, formed between them, pockets 5 for receiving a respective rolling body 20.

In order to guide the rolling bodies 20 inside the pockets 5 the connecting webs 4 have guiding elements 6 which ensure positioning of the rolling bodies 20 inside the pockets 5. For each adjacent pocket 5 two guiding elements 6 are provided on each connecting web 4, said guiding elements projecting in the same direction from the connecting webs 4 with respect to the axial direction of the cage to be formed by means of the cage segments 1. Moreover the guiding elements 6 also act as bracing elements in order to brace the cage, for example in the event of thermally induced expansion, with respect to the track of an outer race. In each case a projection 7 is provided in a side of the connecting webs 4 situated opposite with respect to the radial direction of the cage, said projection bracing the cage segment 1 if necessary on a travel surface (not shown) of the inner race. By means of the guiding elements 6 on the one hand and the projections 7 on the other hand undesirable displacement of the cage with respect to the rolling bodies can be prevented. Preferably the outer circumference formed by the ends 6a of the guiding elements is smaller than the circumference of the inner race track (not shown) in order to allow a small amount of expansion of the cage.

The circumferential webs 2, 3 have two flanges 2a, 2b, 3a, 3b so that they have an L-shaped cross-section in the circumferential direction. In each case one of the flanges extends in the radial direction of cage. In order to brace the flanges of the L-shaped circumferential webs 2, 3 which extend in the radial direction, against a bearing pressure, bracing elements 8 are provided at regular intervals on the circumferential webs 2, 3 so that a predefined angle, for example a right angle, between the flanges of the circumferential webs 2, 3 is ensured.

The cage segment 1 shown has four pockets 5 which are formed by five connecting webs 4. The two outer connecting webs form simultaneously end sides 9 of the cage segment 1 which in the assembled state are situated opposite end sides or end faces of other cage segments. Unlike the inner connecting webs 4, the outer connecting webs, since they are situated in each case adjacent to only one pocket, each have only two guiding elements 6 for guiding rolling bodies inside the pocket of the respective cage segment.

The cage segment 1 has in the example of the embodiment shown four pockets for rolling bodies, although a greater or smaller number of pockets and preferably pockets for 2 to 10 rolling bodies may be provided.

Two coupling webs 10 are provided on a first of the end sides 9 of the cage segment 1 and form an extension of the circumferential webs 2, 3. On the oppositely situated second end side 9 of the cage segment 1 the circumferential webs 2, 3 have corresponding coupling recesses 11 inside which corresponding coupling webs 10 of another identically constructed cage segment 1 can engage. The coupling recess 11 in the embodiment shown in FIG. 1 is formed by means of tapering of the circumferential webs 2, 3. In particular, the circumferential webs 2,3 have in the region of the coupling recesses no L-shaped cross-section, i.e. the flanges 2b, 3b are missing here.

In the region of the coupling recess 11 latching projections 12 are provided both on the inner circumferential web 2 and on the outer circumferential web 3, these latching projections acting as latching elements. In a complementary manner latching recesses 13 are provided on the coupling webs 10 and form latching edges for the latching projections 12. The latching projections 12 taper outwards in the radial direction and the latching recesses 13 are formed with a corresponding complementary form. In this way two identical cage segments can be engaged inside each other in the radial direction so that they are coupled together in a form-fitting manner with respect to tensile forces in the circumferential direction. The tapering form of the latching projection 12 and the corresponding form of the latching recess 13 have the function of ensuring that the cage segments 1 can only be connected together in one direction and can then be disengaged from each other again in the opposite direction so that assembly of the cage is made easier.

The geometrical forms of the coupling webs and the coupling recesses are preferably adapted so that the coupling webs can be slidably received inside the coupling recesses 11. The geometrical forms of the engaging projections 12 and the locking recess 13 are preferably determined relative to each other such that a clearance fit is formed in the latched, i.e. mutually engaged, condition, this allowing displacement of the cage segments 1 against each other in the circumferential direction of the cage along a given path. The clearance fit has a size such that, during operation of the roller bearing, any swelling and thermal expansion of each cage segment 1 are absorbed. In particular, the clearance fit may have a size such that a clearance equal to 0.1 to 2% of the circumferential length of the cage segment 1 is provided. In particular, the clearance fit may be equal to 1% of the length of the cage segment in the circumferential direction.

The latching projection 12 inside the recess 11 of the first circumferential web 2 and the latching projection 12 in the recess 11 of the second circumferential web 3 each extend outwards in the longitudinal direction L (of the rolling bodies, not shown). Correspondingly the latching recesses 13 on the coupling webs 10 are provided opposite each other on the portions of the coupling webs 10 situated on the inside with respect to the cage segment 1.

FIG. 2 shows a part of a cage for a roller bearing with cage segments 1, such as those shown in FIG. 1, in an assembled condition. It can be seen that the cage segments are connected together by means of mutual engagement, the cage segments being substantially engaged inside each other in the circumferential direction. When the inner and outer circumferential webs 2, 3 of the individual segments are connected together, the respective projection 12 is received inside the latching recess 13 with a clearance fit so that at least a degree of play exists with respect to a pressure but preferably also with respect to a tensile force in the circumferential direction. The dimensions of the cage segments 1 are preferably chosen so that, in the case of an average surrounding temperature or at room temperature, each of the coupling units between the cage segments 1 has a clearance fit in the direction of both tensile force and pressure relative to the circumferential direction. The length of the cage segment 1 is substantially chosen so that a roller bearing cage with a number of cage segments 1 equal to a whole number can be formed. Furthermore it can be seen in FIG. 2 how the rolling bodies 20 are retained inside the pockets 5 of the cage segments 1 with the aid of the guiding elements 6. Thus operating temperatures of up to 150° C. can be absorbed.

The cage segment 1 is preferably made of a thermoplastic synthetic material with glass, carbon or aramide fiber reinforcement. For example, polyether ether ketone with a fiber content of between 10 and 50% by weight (preferably 15 to 25% by weight) may be used as the base material. Further additives such as toughness modifiers and anti-ageing agents may also be used in the material of the cage segment 1.

The cages or the segments formed by the cage segments 1 may be designed in different ways with regard to guiding of the rolling bodies, i.e. essentially in any combination of the following: inner race edge guiding, outer race edge guiding, inner race track guiding, outer race track guiding and/or rolling body guiding. In particular, in addition to embodiments with rolling body guiding, inner race track guiding and/or inner race edge guiding, embodiments with inner race track guiding and/or outer race edge guiding are also possible.

Moreover embodiments which are designed with rolling body guiding, inner race (or outer race) track guiding and/or inner race edge or outer race edge guiding may also be considered. Also possible are outer race track guiding systems if necessary in combination with outer race edge guiding systems or inner race edge guiding systems.

In FIG. 3 a perspective view of a cage segment 1 according to a further embodiment of the present invention is shown. For the description of this embodiment the same reference numbers are used for identical parts or parts with an identical or comparable function. Thus the cage segment 1 shown has a first (inner) circumferential web 2, a second (outer) circumferential web 3, connecting webs 4, pockets 5, guiding elements 6, projections 7, bracing elements 8 and end sides 9. The coupling webs 10 are designed, as in the embodiment according to FIG. 1, as an extension of the circumferential webs 2, 3, but, each have, instead of the latching recess 13, a pin 15 which projects from the coupling web 10 in a direction different from the circumferential direction, in particular perpendicular thereto and acts as a latching element. On the end side 9 situated opposite the end side 9 provided with the coupling webs 10 the circumferential webs 2, 3 correspondingly have coupling recesses 11 which are designed so as to receive the coupling webs 10 of another cage segment. In the region of the coupling recesses 11 the circumferential webs 2, 3 have a latching recess 16 in the form of a through-hole in order to receive the corresponding pin 15 on the coupling web of another cage segment.

The latching recess 16 and the corresponding pin 15 of two cage segments 1 have dimensions in the coupled condition such that a clearance fit exists, i.e. the respective coupling web 10 can slide inside the recess 11 of the corresponding adjacent cage segment 1 within the range of play provided by a plug-in connection between the pin 15 and the latching recess 16.

In the embodiment according to FIG. 3 the circumferential webs are also designed in an L shape with bracing elements 8, the connecting webs 4 having guiding elements 6 which are directed in the direction of the corresponding flange of the L-shaped circumferential webs 2, 3. The sliding projections 7 are correspondingly directed away from the bearing surface of the cage segment 1.

FIG. 4 shows a part of a cage with cage segments according to FIG. 3 and rolling bodies 20 which are inserted. The cage segments, as shown in FIG. 4, are connected together in a similar manner to the cage segments 1 according to the first embodiment by means of engagement inside each other.

FIG. 5 shows a further embodiment of a cage segment according to the invention. Here, the coupling units are designed in a different manner to that of the embodiment shown in FIG. 3. The coupling webs 10 in this embodiment have latching recesses 19 inside which latching projections 18 of another cage segment can engage. In the case of this embodiment each of the latching projections 18 project outwards in the longitudinal direction L of the cage segment.

FIG. 6 shows a detailed view of two cage segments engaging inside each other. It can be seen that the latching projection 18 inside the latching recess 19 has a certain degree of play in the circumferential direction of the cage segment so that, as mentioned initially, it is possible to absorb the thermally induced expansions.

FIG. 7 shows a further embodiment of a cage segment according to the invention. A significant difference of this cage segment consists in the fact that here the coupling units are formed asymmetrically. Whereas in the previous embodiments both the inner circumferential web 2 and the outer circumferential web 3 always have the coupling webs 10 on one side, in the case of the embodiment shown in FIG. 7 the outer circumferential web 3 has a left-sided coupling web 10 and the inner circumferential web 2 has a right-sided coupling web 10 (in each case with reference to FIG. 7). The corresponding coupling recesses are here provided on the outer circumferential web 3 on the right-hand side and on the inner circumferential web 2 on the left-hand side. The engagement of the individual cage segments inside further cage segments is performed in a similar manner to that already described in connection with FIG. 3. The guiding surfaces for the rolling bodies are also formed in a different manner, more specifically they extend substantially continuously in the longitudinal direction of the cage segment and also have small protuberances 6b on their ends in the radial direction.

To summarize, one idea of the present invention consists in connecting together the cage segments forming the cage of a roller bearing by means of corresponding coupling units. The coupling units are designed in such a way that the connection between two cage segments is provided with play. In this way a uniform distribution of play over the entire circumference of the cage is produced so that the cage segments are able to maintain their respective positions even in the event of swelling and/or thermal expansion. Furthermore, as a result, it is possible to prevent substantially, or reduce greatly, an impact of the individual cage segments against each other.

The coupling geometry between the cage segments is configured so that a small clearance fit is provided, without stressing under pressure and with the possibility of releasing the connection upon application of a tensile force in the circumferential direction. Moreover, coupling back again is also possible.

All the features disclosed in the application documents are claimed as being essential to the invention insofar as, either individually or in combination, they are novel with respect to the state of the art.

### LIST OF REFERENCE NUMBERS

1 Cage segment
2 Inner circumferential web
2a,2b Flange of the inner circumferential web
3 Outer circumferential web
3a,3b Flange of the outer circumferential web
4 Connecting web
5 Pocket
6 Guiding element
6a End surface of the guiding element
6b Protuberance
7 Sliding projection
8 Bracing element
9 End side
10 Coupling web
11 Coupling recess
12 Latching projection
13 Latching recess
15 Pin
16 Additional latching recess
18 Latching projection
19 Latching recess
20 Rolling body
L Longitudinal direction of the cage segment

1. Cage segment for the cage of a roller bearing comprising: at least two circumferential webs extending in the circumferential direction and at least two connecting webs, the circumferential webs and the connecting webs forming at least one pocket for receiving a rolling body, wherein the cage segment has a coupling unit which is designed to connect the end side of the cage segment to another cage segment.

2. Cage segment according to claim 1, wherein the coupling unit is designed in such a way that a connection with another cage segment has a clearance fit.

3. Cage segment according to claim 2, wherein the coupling unit is configured such that the clearance fit of the coupling unit has a value to absorb swelling and thermal expansion of the cage segment.

4. Cage segment according to claim 2, wherein a first coupling element is provided on a first end side and a second coupling element is provided on a second end side, said coupling elements being designed so as to complement each other.

5. Cage segment according to claim 4, wherein the first and the second coupling elements are designed such that they may be connected together in a form-fitting manner.

6. Cage segment according to claim 4, wherein the first and the second coupling elements are designed as complementary plug-in connecting elements.

7. Cage segment according to claim 4, wherein the first coupling element has a coupling web projecting in the circumferential direction and the second coupling element has a coupling recess for receiving the coupling web of a first coupling element of a further cage segment.

8. Cage segment according to claim 7, wherein the coupling web is designed as an extension of the circumferential webs.

9. Cage segment according to claim 7, wherein the coupling web is provided with a latching element projecting therefrom and a latching recess is provided in the region of the coupling recess, said latching recess being able to be engaged behind by the latching element of a first coupling element of a further cage segment with respect to the circumferential direction, so as to provide a form-fitting connection.

10. Cage segment according to claim 9, wherein the latching element is designed as a pin which can be received inside a latching opening in the coupling recess of the second coupling element.

11. Cage segment according to claim 7, wherein the coupling web is provided with a latching recess and a latching element Is provided in the region of the coupling recess so as to engage into the latching recess of a first coupling element of a further cage segment with respect to the circumferential direction, so as to provide a form-fitting connection.

12. Cage segment according to claim 1, wherein the cage segment is formed with a thermoplastic synthetic material, in particular with a glass, carbon or aramide reinforcement.

13. Cage segment according to claim 12, wherein the thermoplastic synthetic material comprises polyether ether ketone with a fiber content of between 10 to 50% by weight.

14. Cage for a roller bearing comprising several cage segments according to claim 1, wherein the cage segments are connected together at their end sides with the aid of the coupling units so that they form a closed ring.

15. Roller bearing comprising: a cage according to claim 14 with an outer race, wherein the connecting webs of the cage are situated at a distance from a track of the outer race in a radial direction of the roller bearing.

16. Roller bearing according to claim 15, wherein the inner radius of the track of the outer race and the geometrical outer radius of the connecting webs are coordinated in such a way that swelling or thermally induced increases in diameter of the outer cage can be absorbed.
